(19) United States
(12) Patent Application Publication
(10) Pub. No.: US 2025/0155035 A1
(43) Pub. Date: May 15, 2025

(54) Compact and Modular Valve

(71) Applicant: Illinois Tool Works Inc., Glenview, IL (US)

(72) Inventor: Andrew Swantek, Park RIdge, IL (US)

(21) Appl. No.: 18/824,017

(22) Filed: Sep. 4, 2024

Related U.S. Application Data
(60) Provisional application No. 63/548,421, filed on Nov. 14, 2023.

(51) Int. Cl. F16K 11/087

(52) U.S. Cl. CPC F16K 11/0873

(57) ABSTRACT

Disclosed is a valve core for adjusting fluid flow in a multi-port valve assembly having a valve body defining a valve seat. The valve core includes a valve plug, and a valve stem. The valve plug defines two or more flow channels to facilitate fluid flow between two or more channel ports. The valve plug is configured to rotate within the valve seat about an axis of rotation between a first position and a second position. The valve stem extends outwardly from the valve plug.

### RELATED APPLICATIONS

The present application claims priority to U.S. Provisional Patent Application No. 63/548,421, filed Nov. 14, 2023, and entitled “Compact and Modular Valve,” which is hereby incorporated by reference in its entirety.

### BACKGROUND

A multi-way valve, also known as a multi-port valve, is a type of valve with multiple openings or ports for the flow of fluids, often used in various industrial and mechanical applications. These valves allow for the redirection or switching of fluid flow between different pathways, and they are commonly used in hydraulic and pneumatic systems, as well as in heating, ventilation, and air conditioning (HVAC) systems. Multi-way valves are often used for functions such as reversing the direction of hydraulic cylinders, controlling the movement of pneumatic actuators, and managing the flow of fluids in a closed-loop system.

Additionally, electrified vehicles (e.g., battery-electric vehicles (BEVs), plug-in hybrid-electric vehicles (PHEVs), mild hybrid-electric vehicles (MHEVs), or full hybrid-electric vehicles (FHEVs)) contain an energy storage device, such as a high voltage (HV) battery, to act as a propulsion source for the vehicle. The HV battery may include components and systems to assist in managing vehicle performance and operations. Vehicle cabin climate control systems may operate with engine thermal management systems to provide efficient distribution of heat via refrigerants and coolant flowing throughout a heat pump system having one or more multi-way valves. A control system may direct operation of the multi-way valves. Four-way valves, a type of multi-port valve, are known for various uses and purposes in a variety of fluid circuits, to change fluid flow paths in the fluid circuit. By manipulating the valve, fluid can be directed to different combinations of these ports to control the motion or operation of various components within a system. The specific function and operation of a multi-way valve can vary depending on the application and the type of system it is used in.

Existing multi-port valves need to replace the valve core to facilitate fluid routing in four, five, or six-way valves, which leads to additional cost and complexity. Therefore, despite advancements, a need exists for a multi-port valve having a valve core configured to work with various systems that are not limited to a particular number of ports.

### SUMMARY

The present disclosure relates generally to a multi-port valve and a valve core, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric view of an example multi-port valve system in an assembled configuration.

FIG. 1b illustrates an isometric view of the multi-port valve system in a disassembled configuration.

FIG. 1c illustrates an assembly view of the multi-port valve assembly.

FIG. 2a illustrates a top plan view of the multi-port valve assembly in accordance with a first example.

FIG. 2b illustrates a top plan cross-sectional view of the multi-port valve assembly taken along cutline A-A (FIG. 1b).

FIGS. 2c through 2f illustrate top plan cross-sectional views of the multi-port valve assembly with the valve core oriented at different rotational positions to adjust flow rate.

FIGS. 2g and 2h illustrate top plan cross-sectional views of the multi-port valve assembly with the valve core oriented at different rotational positions to redirect flow routing.

FIG. 3a illustrates a top plan view of the multi-port valve assembly in accordance with a second example.

FIG. 3b illustrates a top plan cross-sectional view of the multi-port valve assembly taken along cutline A-A (FIG. 1b).

FIGS. 3c through 3f illustrate top plan cross-sectional views of the multi-port valve assembly with the valve core oriented at different rotational positions to adjust flow rate.

FIGS. 3g and 3h illustrate top plan cross-sectional views of the multi-port valve assembly with the valve core oriented at different rotational positions to redirect flow routing.

FIG. 4a illustrates a top plan view of the multi-port valve assembly in accordance with a third example.

FIG. 4b illustrates a top plan cross-sectional view of the multi-port valve assembly taken along cutline A-A (FIG. 1b).

FIGS. 4c through 4f illustrate top plan cross-sectional views of the multi-port valve assembly with the valve core oriented at different rotational positions to adjust flow rate.

FIGS. 5a and 5b illustrate top plan cross-sectional views of the multi-port valve assembly with the valve core oriented at different rotational positions to redirect flow routing.

FIGS. 6a through 6d illustrate top plan cross-sectional views of example valve cores taken along cutline B-B (FIG. 1c).

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Existing multi-port valve assemblies need to replace the valve core to create four, five, or six-way valves, which leads to additional cost and complexity. To reduce cost and complexity, disclosed is a multi-port valve assembly having a valve core configured to route fluid in one or more of a four, five, or six-way valves, thus resulting in a single valve core that can be used to build 3 different valves. This saves cost, reduces complexity, and makes the valve more modular. Additionally, several modern architectures split flow to parallel paths (e.g. front and rear drive units), which may be enabled by this valve and reduce downstream fluid routing complexity.

In one example, a valve core for adjusting fluid flow in a multi-port valve assembly having a valve body defining a valve seat comprises: a valve plug defining two or more flow channels configured to facilitate fluid flow between two or more channel ports, wherein the valve plug is configured to rotate within the valve seat about an axis of rotation between a first position and a second position; and a valve stem extending outwardly from the valve plug. In some examples, each of the two or more flow channels is configured to facilitate fluid flow between three channel ports. In some examples, at least one of the two or more flow channels is generally Y-shaped, generally T-shaped, generally linear, or a right angle. The valve core is configured to adjust fluid flow in a multi-port valve assembly having four ports, five ports, and/or six ports.

In another example, a multi-port valve assembly for adjusting fluid flow comprises: a valve body defining a valve seat fluidly coupled to each of a plurality of ports, wherein the plurality of ports comprises a first port, a second port, a third port, and a fourth port; and a valve core having a valve plug and a valve stem extending outwardly from the valve plug, wherein the valve plug defines two or more flow channels, and wherein the valve plug is configured to rotate within the valve seat about an axis of rotation between a first position and a second position to redirect or throttle a flow rate between two or more of the plurality of ports via the two or more flow channels. In some examples, the plurality of ports further comprises a fifth port and/or a sixth port.

In some examples, when the valve plug is in the first position, the first port is fluidly coupled to each of the second port and the third port and the fourth port is fluidly coupled to each of the fifth port and sixth port. When the valve plug is in the second position, the first port is fluidly coupled to each of the fifth port and sixth port and the third port is fluidly coupled to each of the second port and fourth port. In some examples, the valve plug is configured to rotate within the valve seat between the first position and the second position via one or more intermediate positions that throttle the flow rate.

In some examples, each of the two or more flow channels is configured to facilitate fluid flow between three channel ports formed in the valve plug. In some examples, at least one of the two or more flow channels is generally Y-shaped, generally T-shaped, generally linear, or a right angle.

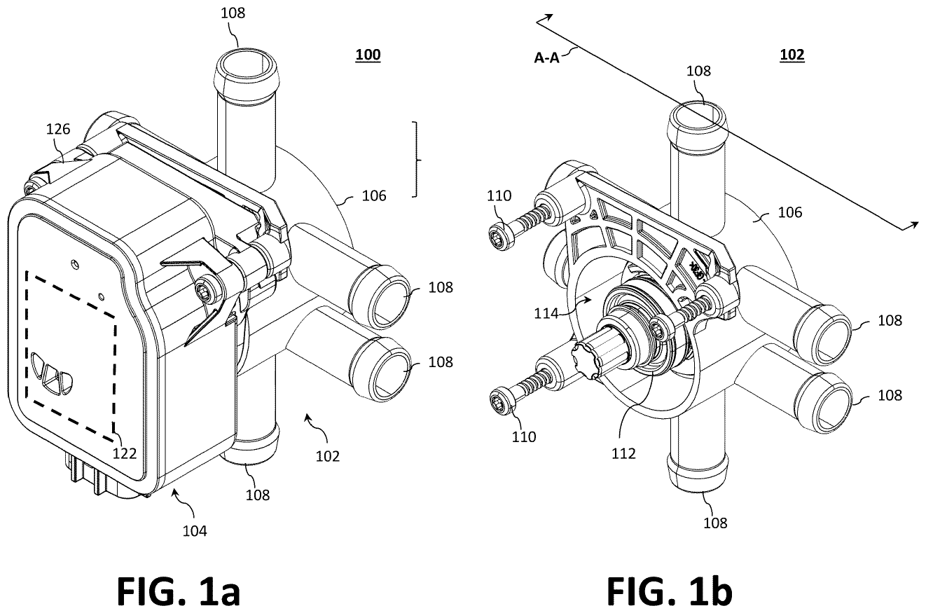

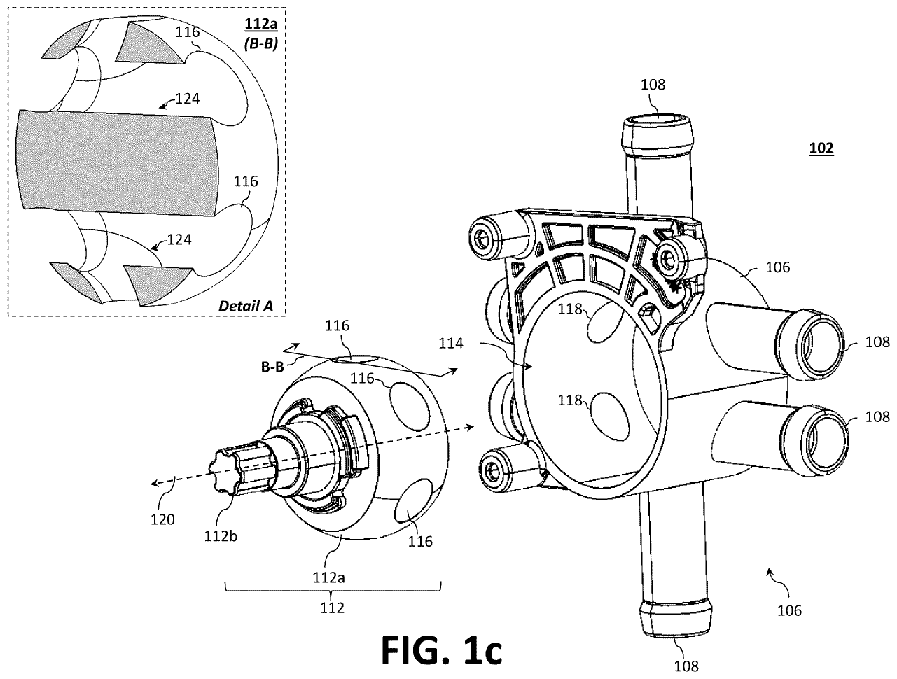

FIGS. 1a and 1b illustrate, respectively, isometric views of an example multi-port valve system 100 in assembled and disassembled configurations. As illustrated, the multi-port valve system 100 generally comprises a multi-port valve assembly 102 and an actuator assembly 104. The actuator assembly 104 can be coupled to the multi-port valve assembly 102 via one or more fasteners 110 (e.g., bolts, screws, etc.). FIG. 1c illustrates an assembly view of the multi-port valve assembly 102.

The multi-port valve assembly 102 includes a valve body 106 that includes, forms, or otherwise defines a plurality of ports 108 having fluid line connection features to which fluid conduits (e.g., hoses) in a fluid circuit can be connected, such as, for example various coolant lines in a vehicle cooling system circuit. Internally, the valve body 106 defines a valve seat 114 that receives and cooperates with a valve core 112 to control and direct the flow of fluid through multi-port valve assembly 102 between and among the various ports 108 via housing ports 118. As illustrated, the housing ports 118 are formed in and/or distributed around a sidewall of the valve seat 114. In the illustrated example, each housing port 118 is associated with a port 108, which, depending on its configuration and/or the position of the valve core 112, serves as inlet to and/or outlets from multi-port valve assembly 102).

The multi-port valve system 100 or a portion thereof (e.g., the valve core 112) can be fabricated from, for example, a synthetic or semi-synthetic polymers (e.g., plastics, such as acrylonitrile butadiene styrene (ABS) and polyvinyl chloride (PVC), etc.), composite materials (e.g., fiber glass), or a combination thereof using a plastic injection technique, additive manufacturing, or otherwise. In some examples, the multi-port valve system 100 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In other examples, the multi-port valve system 100 may be fabricated from a metal (or a metal alloy).

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, portions of the multi-port valve system 100 may be formed or otherwise fabricated at different resolutions during a printing operation.

The valve core 112 generally comprises a valve plug 112a and a valve stem 112b extending therefrom (e.g., perpendicularly therefrom). In the exemplary embodiment shown, the valve plug 112a is a generally cylindrical element that defines one or more flow channels 124 configured to facilitate fluid flow between two or more channel ports 116 formed on the outer wall of the generally cylindrical element. The channel ports 116 are sized and shaped to enable fluid flow to the ports 108 via the housing ports 118 formed in the valve seat 114. The multi-port valve assembly 102 can further comprise one or more seals (e.g., gaskets, O-rings, or the like) at the interface between the channel ports 116 and the housing ports 118.

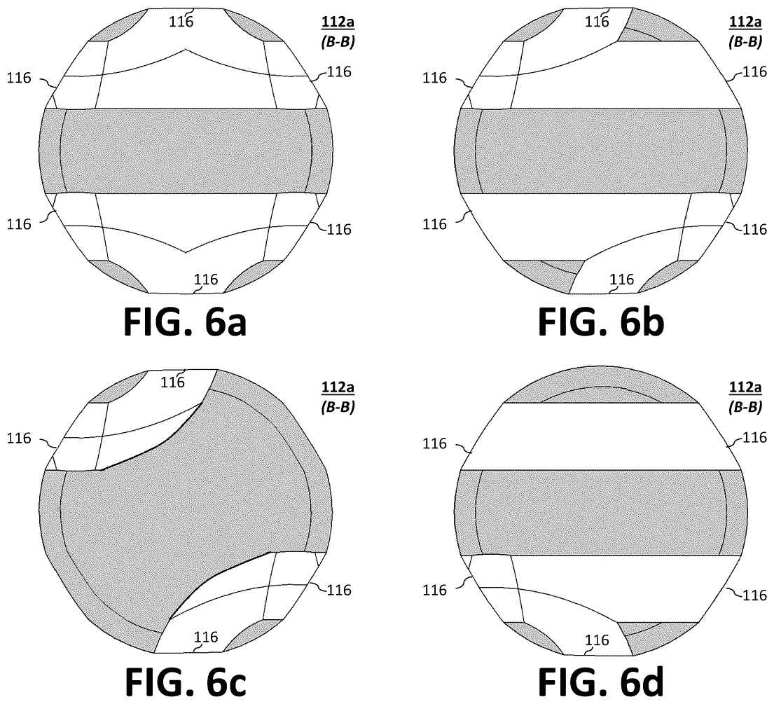

The one or more seals may be provided on one or both of the valve plug 112a and valve seat 114 at, adjacent, and/or around the respective channel ports 116 and housing ports 118. In operation, the one or more seals serve to provide fluid flow between the flow channels 124 of the valve core 112 and the port(s) 108 while mitigating seepage into the valve seat 114. In the illustrated example, the valve plug 112a defines two flow channels 124, each of which includes three channel ports 116 and is generally Y-shaped. In the illustrated example, the flow channels 124 form a lower case Y-shape (e.g., a generally linear primary path with a secondary path positioned at an obtuse angle); however, an upper case Y-shape (e.g., a generally linear primary path that splits to define two mirrored secondary paths positioned at an obtuse angles relative to the primary path). While the two flow channels 124 are illustrated as generally Y-shaped, other shapes are contemplated depending on the desired flow path, examples of which will be described in connection with FIGS. 6a through 6d.

The actuator assembly 104 generally comprises a housing 126 and an actuator 122 (e.g., an electric motor) positioned in or by the actuator assembly 104. The actuator 122 is configured to mechanically engage the valve stem 112b. In operation, the actuator 122 is configured to rotate the valve plug 112a about an axis of rotation 120 via the valve stem 112b to orient the valve core 112 in one of multiple rotational positions. Adjusting the rotational position of the valve core 112 can be used to adjust fluid flow rate and/or redirect flow routing between two or more ports 108. For example, the actuator 122 can rotate the valve plug 112a about the axis of rotation 120 to transition the valve core 112 from a first position (e.g., a full flow position) where one or more channel ports 116 are fully aligned with one or more housing ports 118 to a second position (e.g., a no flow position) where the one or more channel ports 116 are fully misaligned with the one or more housing ports 118 via one or more intermediate positions (e.g., partial or intermediate flow positions) to a variable flow rate. A control system may be operably coupled to the actuator assembly 104 and configured to direct operation of the multi-port valve assembly 102 via the actuator 122.

Whereas existing multi-port valve assemblies need to replace the valve core to create four, five, or six-way valves, the disclosed valve core 112 is configured to route fluid in one or more of a four, five, or six-way valves, thus resulting in a single valve core 112 that can be used to build 3 different valves.

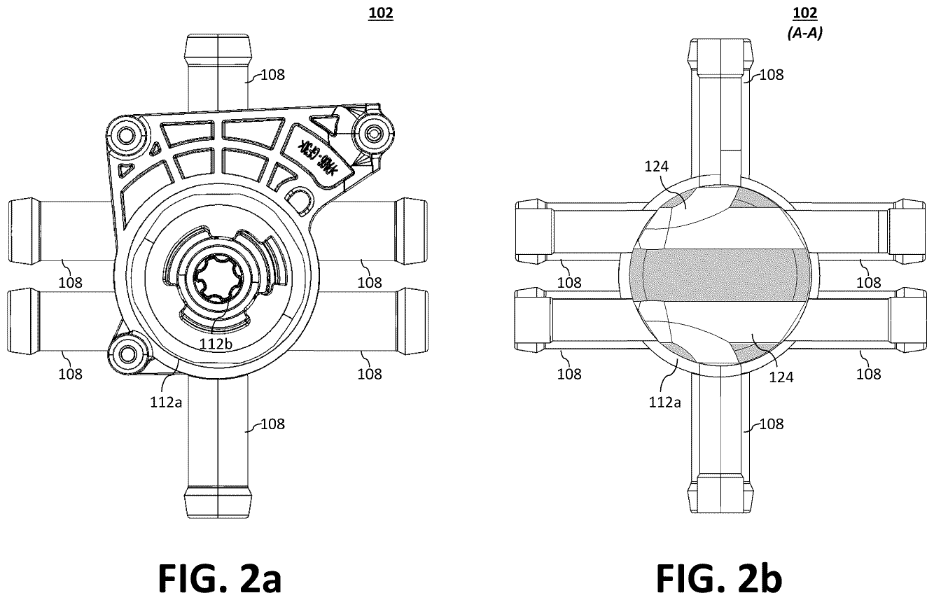

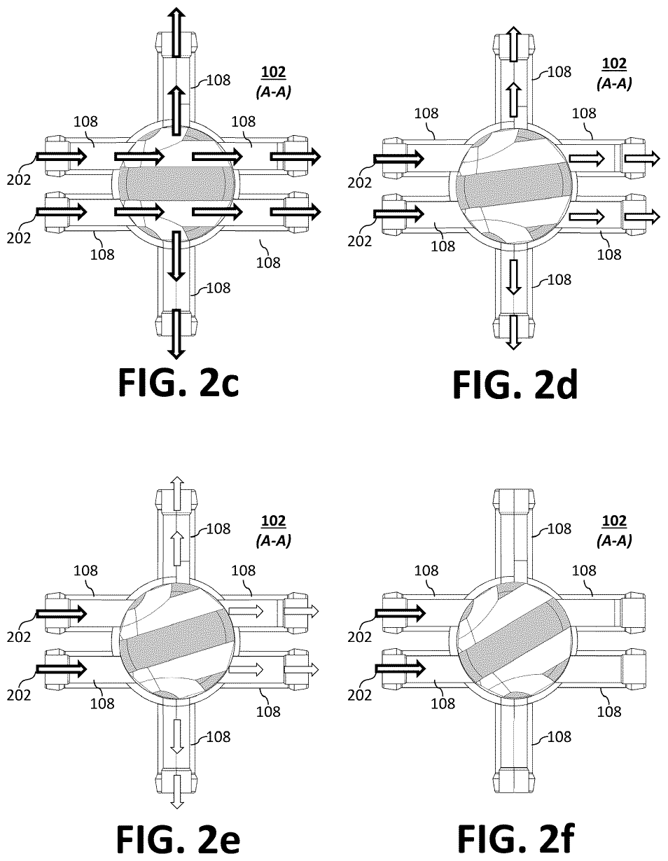

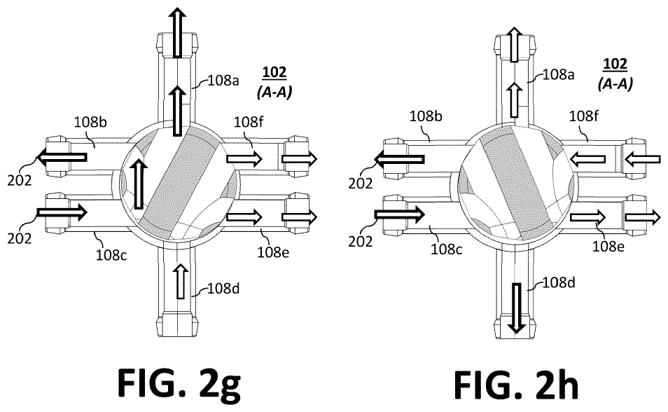

FIG. 2a illustrates a top plan view of the multi-port valve assembly 102 in accordance with a first example, while FIG. 2b illustrates a top plan cross-sectional view of the multi-port valve assembly 102 taken along cutline A-A (FIG. 1b). FIGS. 2c through 2f illustrate top plan cross-sectional views of the multi-port valve assembly 102 with the valve core 112 oriented at different rotational positions to adjust flow rate.

In this example, the multi-port valve assembly 102 is a six-port valve (i.e., it has six ports 108) and the valve core 112 is configured to fluidly couple the six ports 108 to selectively define (e.g., based on its rotational position) a set of Y-shaped flow paths. As best illustrated in FIGS. 2c through 2f, the rotational position of the valve core 112 can be adjusted to control a fluid flow rate between two or more ports 108.

Turning to FIG. 2c, the valve core 112 can be positioned such that each of its channel ports 116 are aligned with the housing ports 118 such that full fluid flow is possible. In this example, fluid 202 (represented using arrows) enters via one port 108 (serving as an inlet) and exits via two ports 108 (serving as outlets). However, fluid flow could be reversed such that fluid 202 enters via two ports 108 (serving as inlets) and exits one port 108 (serving as an outlet).

Turning to FIG. 2d, the valve core 112 is rotated about the axis of rotation 120 to assume a new rotational position such that each of its channel ports 116 are partially misaligned with the housing ports 118 such that fluid flow is partially obstructed. In this example, fluid 202 still enters via one port 108 (serving as an inlet) and exits via two ports 108 (serving as outlets), but the flow rate is reduced (e.g., throttled). For example, the valve core 112 can rotated about the axis of rotation 120 such that the flow rate is reduced by 1/3.

Turning to FIG. 2e, the valve core 112 is rotated about the axis of rotation 120 to assume a new rotational position such that each of its channel ports 116 are further misaligned with the housing ports 118 such that fluid flow is further obstructed. In this example, fluid 202 again enters via one port 108 (serving as an inlet) and exits via two ports 108 (serving as outlets), but the flow rate is further reduced. For example, the valve core 112 can rotated about the axis of rotation 120 such that the flow rate is reduced by 2/3.

Turning to FIG. 2f, the valve core 112 is rotated about the axis of rotation 120 to assume a new rotational position such that each of its channel ports 116 are fully misaligned with the housing ports 118 such that fluid flow is fully obstructed. In this example, the flow rate is fully reduced. For example, the valve core 112 can rotated about the axis of rotation 120 such that the flow is prohibited. In other words, the one or more channel ports 116 abut the sidewall of the valve seat 114 and the one or more housing ports 118 abut the sidewall of the valve plug 112a, thus preventing fluid flow.

With reference to FIGS. 2g and 2h, illustrated is a multi-port valve assembly 102 having six ports 108 (i.e., a first port 108a, a second port 108b, a third port 108c, a fourth port 108d, a fifth port 108e, and a sixth port 108f) where the valve core 112 can be adjusted to redirect flow. With reference to FIG. 2g, when in a first rotational position, fluid 202 enters the multi-port valve assembly 102 via the third port 108c and the fourth port 108d, and exits via the first port 108a and the second port 108b and the fifth port 108e and sixth port 108f. In other words, the first port 108a is fluidly coupled to the second port 108b and the third port 108c and the fourth port 108d is fluidly coupled to the fifth port 108e and sixth port 108f. Fluid flow can be reversed if and as needed for a given installation.

With reference to FIG. 2h, the valve core 112 is rotated about the axis or rotation 120 from the first rotational position to a second rotational position. In this example, the valve core 112 is rotated about the axis or rotation 120 by about 60 degrees, though other angular rotations are possible depending on the shape/quantity of the flow channels 124 and location/quantity of the ports 108. Now, fluid 202 enters the multi-port valve assembly 102 via the third port 108c and the sixth port 108f, and exits via the first port 108a, the second port 108b, the fourth port 108d, and the fifth port 108e. In other words, the first port 108a is fluidly coupled to the fifth port 108e and sixth port 108f and the third port 108c is fluidly coupled to the second port 108b and fourth port 108d.

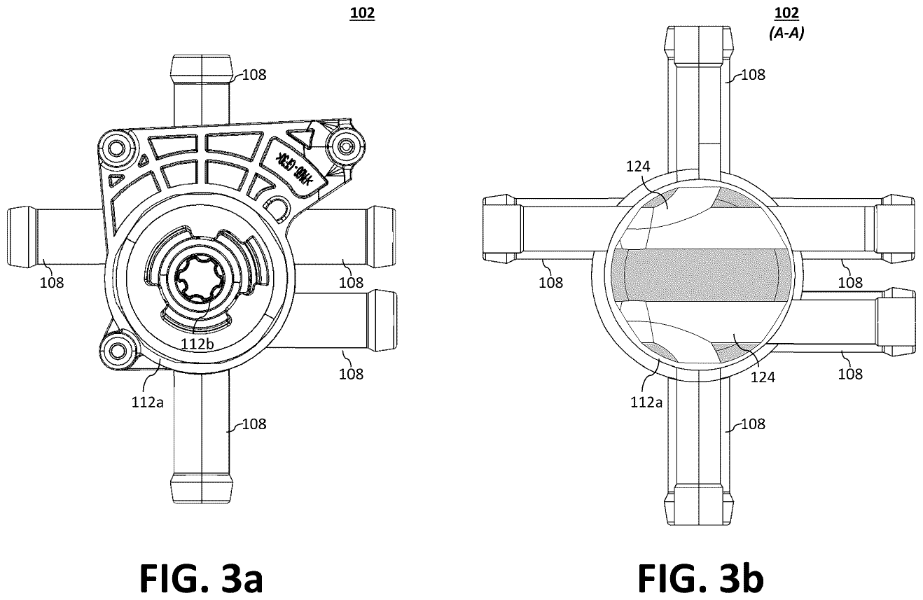

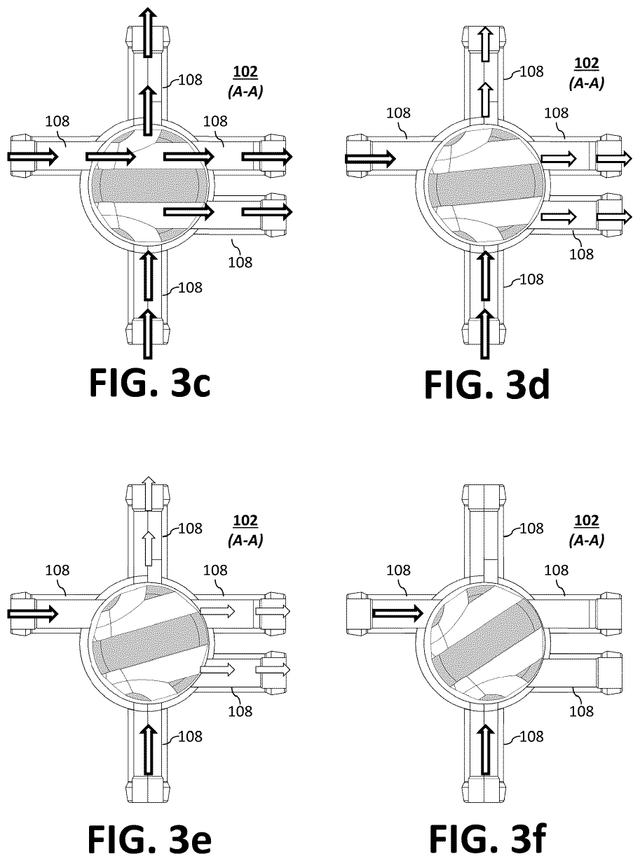

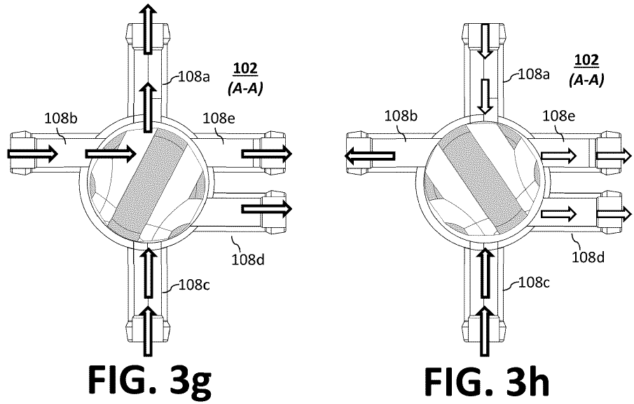

FIG. 3a illustrates a top plan view of the multi-port valve assembly 102 in accordance with a second example, while FIG. 3b illustrates a top plan cross-sectional view of the multi-port valve assembly 102 taken along cutline A-A (FIG. 1b). FIGS. 3c through 2f illustrate top plan cross-sectional views of the multi-port valve assembly 102 with the valve core 112 oriented at different rotational positions to adjust flow rate.

In this example, the multi-port valve assembly 102 is a five-port valve (i.e., it has five ports 108) and the valve core 112 is configured to fluidly couple the five ports 108 to selectively define (e.g., based on its rotational position) a set of Y-shaped flow paths. As best illustrated in FIGS. 3c through 3f, the rotational position of the valve core 112 can be adjusted to control a fluid flow rate between two or more ports 108. The five-port valve operates in substantially the same way as the six-port valve described in connection with FIGS. 2a through 2f except that a port 108 (and its corresponding housing port 118) is omitted or cancelled.

Turning to FIG. 3c, the valve core 112 can be positioned such that each of its channel ports 116 are aligned with the housing ports 118 such that full fluid flow is possible. Turning to FIG. 3d, the valve core 112 is rotated about the axis of rotation 120 to assume a new rotational position such that each of its channel ports 116 are partially misaligned with the housing ports 118 such that fluid flow is partially obstructed. For example, the valve core 112 can rotated about the axis of rotation 120 such that the flow rate is reduced by 1/3. Turning to FIG. 3e, the valve core 112 is rotated about the axis of rotation 120 to assume a new rotational position such that each of its channel ports 116 are further misaligned with the housing ports 118 such that fluid flow is further obstructed. For example, the valve core 112 can rotated about the axis of rotation 120 such that the flow rate is reduced by 2/3. Turning to FIG. 3f, the valve core 112 is rotated about the axis of rotation 120 to assume a new rotational position such that each of its channel ports 116 are fully misaligned with the housing ports 118 such that fluid flow is fully obstructed. In this example, the flow rate is fully reduced.

With reference to FIGS. 3g and 3h, illustrated is a multi-port valve assembly 102 having five ports 108 (i.e., a first port 108a, a second port 108b, a third port 108c, a fourth port 108d, and a fifth port 108e) where the valve core 112 can be adjusted to redirect flow. With reference to FIG. 3g, when in a first rotational position, fluid 202 enters the multi-port valve assembly 102 via the second port 108b and the third port 108c, and exits via the first port 108a and the fourth ports 108d and the fifth port 108e. In other words, the first port 108a is fluidly coupled to the second port 108b and the third port 108c is fluidly coupled to the fourth port 108d and the fifth port 108e. Fluid flow can be reversed if and as needed for a given installation.

With reference to FIG. 3h, the valve core 112 is rotated about the axis or rotation 120 from the first rotational position to a second rotational position. In this example, the valve core 112 is rotated about the axis or rotation 120 by about 60 degrees, though other angular rotations are possible depending on the shape/quantity of the flow channels 124 and location/quantity of the ports 108. Now, fluid 202 enters the multi-port valve assembly 102 via the first port 108a and the third port 108c, and exits via the second port 108b, the third port 108c, and the fourth port 108d. In other words, the first port 108a is fluidly coupled to the fourth port 108d and the fifth port 108e and the third port 108c is fluidly coupled to the first port 108a.

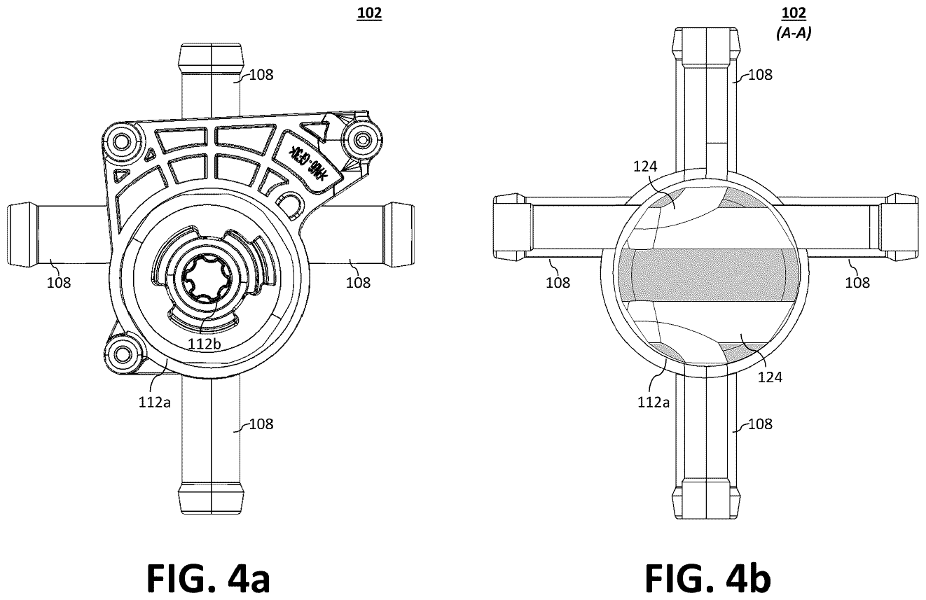

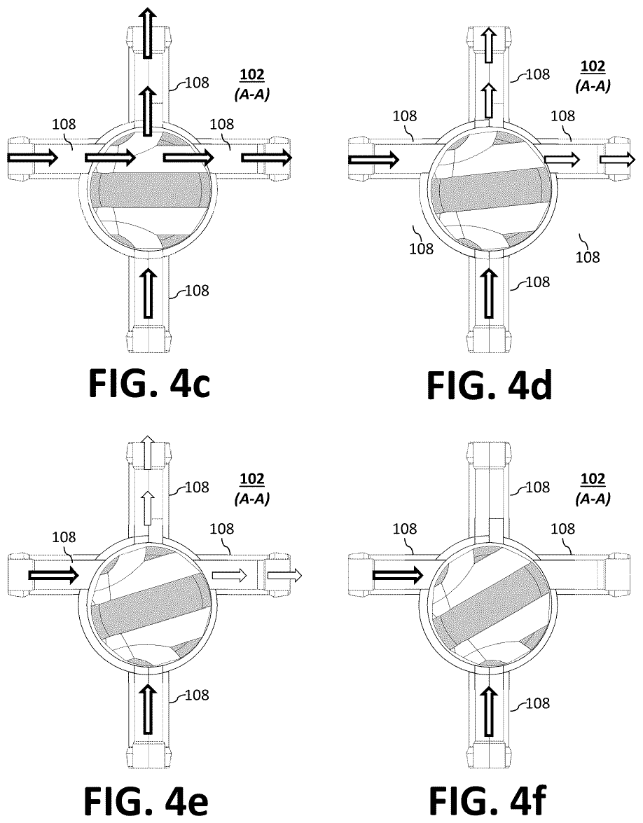

FIG. 4a illustrates a top plan view of the multi-port valve assembly 102 in accordance with a third example, while FIG. 4b illustrates a top plan cross-sectional view of the multi-port valve assembly 102 taken along cutline A-A (FIG. 1b). FIGS. 4c through 4f illustrate top plan cross-sectional views of the multi-port valve assembly 102 with the valve core 112 oriented at different rotational positions to adjust flow rate.

In this example, the multi-port valve assembly 102 is a four-port valve (i.e., it has four ports 108) and the valve core 112 is configured to fluidly couple the four ports 108 to selectively define (e.g., based on its rotational position) a set of Y-shaped flow paths. As best illustrated in FIGS. 4c through 4f, the rotational position of the valve core 112 can be adjusted to control a fluid flow rate between two or more ports 108. The four-port valve operates in substantially the same way as the six-port valve described in connection with FIGS. 2a through 2f except that two ports 108 (and its corresponding housing ports 118) are omitted or cancelled.

Turning to FIG. 4c, the valve core 112 can be positioned such that each of its channel ports 116 are aligned with the housing ports 118 such that full fluid flow is possible. Turning to FIG. 4d, the valve core 112 is rotated about the axis of rotation 120 to assume a new rotational position such that each of its channel ports 116 are partially misaligned with the housing ports 118 such that fluid flow is partially obstructed. For example, the valve core 112 can rotated about the axis of rotation 120 such that the flow rate is reduced by 1/3. Turning to FIG. 4e, the valve core 112 is rotated about the axis of rotation 120 to assume a new rotational position such that each of its channel ports 116 are further misaligned with the housing ports 118 such that fluid flow is further obstructed. For example, the valve core 112 can rotated about the axis of rotation 120 such that the flow rate is reduced by 2/3. Turning to FIG. 4f, the valve core 112 is rotated about the axis of rotation 120 to assume a new rotational position such that each of its channel ports 116 are fully misaligned with the housing ports 118 such that fluid flow is fully obstructed. In this example, the flow rate is fully reduced.

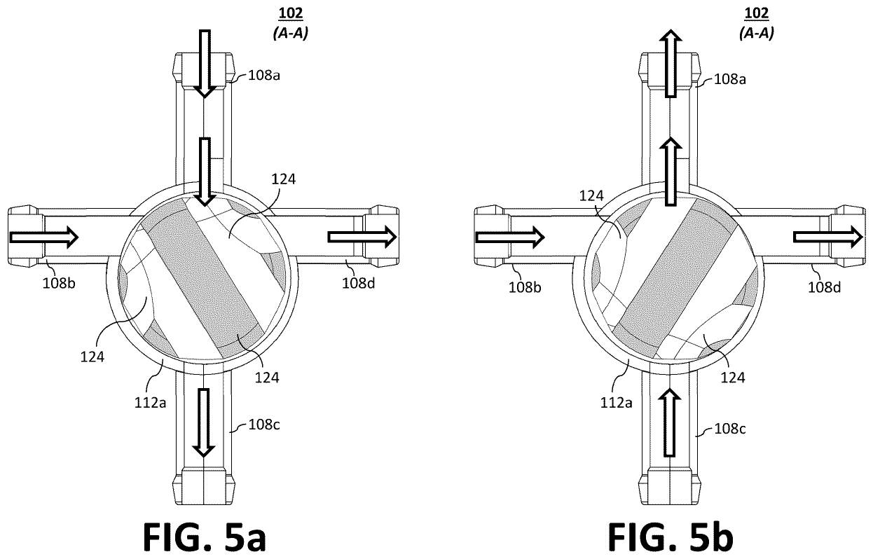

In addition to or in lieu of simply adjusting flow rate, the valve core 112 can oriented at different rotational positions to redirect flow routing. FIGS. 5a and 5b illustrate top plan cross-sectional views of the multi-port valve assembly 102 with the valve core 112 oriented at different rotational positions to redirect flow routing.

In this example, akin to the multi-port valve assembly 102 of FIGS. 4a through 4f, the multi-port valve assembly 102 is a four-port valve having a first port 108a, a second port 108b, a third port 108c, and a fourth port 108d. In this example, the rotational position of the valve core 112 can be adjusted to control a fluid flow direction between two or more of the first port 108a, the second port 108b, the third port 108c, and the fourth port 108d.

With reference to FIG. 5a, when in a first rotational position, fluid 202 enters the multi-port valve assembly 102 via the first port 108a and the second port 108b, and exits via the third port 108c and the fourth port 108d. However, fluid flow could be reversed such that fluid 202 enters via the third port 108c and the fourth port 108d and exits via the first port 108a and the second ports 108b. In other words, the first port 108a is fluidly coupled to the third port 108c and the second port 108b is fluidly coupled to the fourth port 108d.

With reference to FIG. 5b, the valve core 112 is rotated about the axis or rotation 120 from the first rotational position to a second rotational position. In this example, the valve core 112 is rotated about the axis or rotation 120 by about 90 degrees, though other angular rotations are possible depending on the shape/quantity of the flow channels 124 and location/quantity of the ports 108. Now, fluid 202 enters the multi-port valve assembly 102 via the second port 108b and the third port 108c, and exits via the first port 108a and the fourth port 108d. In other words, the first port 108a is now fluidly coupled to the second port 108b and the third port 108c is fluidly coupled to the fourth port 108d.

FIGS. 6a through 6d illustrate top plan cross-sectional views of example valve cores 112 taken along cutline B-B (FIG. 1c). While the prior examples illustrated valve cores having two flow channels 124, each of which being a generally Y-shaped, other shapes are contemplated. FIG. 6a illustrates an example valve core having two flow channels 124, each of which being generally T-shaped. In this example, the flow channels 124 are shaped or contour to return turbulence as the fluid 202 flows. FIG. 6b illustrates an example valve core having two flow channels 124, each of which being generally Y-shaped, but one is mirrors relative to the other. FIG. 6c illustrates an example valve core having two flow channels 124, each of which being generally L-shaped (e.g., defining a right angle). FIG. 6d illustrates an example valve core having two flow channels 124, one of which is a linear flow channel 124 and the other being generally Y-shaped. Those of skill in the art would appreciate that the various flow channel can be selected and/or interchanged to provide a valve core 112 to achieve a desired flow path vis-à-vis a given valve body 106.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A valve core for adjusting fluid flow in a multi-port valve assembly having a valve body defining a valve seat, the valve core comprising:
a valve plug defining two or more flow channels configured to facilitate fluid flow between two or more channel ports, wherein the valve plug is configured to rotate within the valve seat about an axis of rotation between a first position and a second position; and
a valve stem extending outwardly from the valve plug.

2. The valve core of claim 1, wherein each of the two or more flow channels is configured to facilitate fluid flow between three channel ports.

3. The valve core of claim 2, wherein at least one of the two or more flow channels is generally Y-shaped.

4. The valve core of claim 2, wherein at least one of the two or more flow channels is generally T-shaped.

5. The valve core of claim 1, wherein the valve core is configured to adjust fluid flow in a multi-port valve assembly having four ports.

6. The valve core of claim 1, wherein the valve core is configured to adjust fluid flow in a multi-port valve assembly having five ports.

7. The valve core of claim 1, wherein the valve core is configured to adjust fluid flow in a multi-port valve assembly having six ports.

8. A multi-port valve assembly for adjusting fluid flow, the multi-port valve assembly comprising:
a valve body defining a valve seat fluidly coupled to each of a plurality of ports, wherein the plurality of ports comprises a first port, a second port, a third port, and a fourth port; and
a valve core having a valve plug and a valve stem extending outwardly from the valve plug,
wherein the valve plug defines two or more flow channels, and
wherein the valve plug is configured to rotate within the valve seat about an axis of rotation between a first position and a second position to redirect or throttle a flow rate between two or more of the plurality of ports via the two or more flow channels.

9. The multi-port valve assembly of claim 8, wherein the plurality of ports further comprises a fifth port.

10. The multi-port valve assembly of claim 9, wherein the plurality of ports further comprises a sixth port.

11. The multi-port valve assembly of claim 10, wherein, when the valve plug is in the first position, the first port is fluidly coupled to each of the second port and the third port and the fourth port is fluidly coupled to each of the fifth port and sixth port.

12. The multi-port valve assembly of claim 11, wherein, when the valve plug is in the second position, the first port is fluidly coupled to each of the fifth port and sixth port and the third port is fluidly coupled to each of the second port and fourth port.

13. The multi-port valve assembly of claim 10, wherein the valve plug is configured to rotate within the valve seat between the first position and the second position via one or more intermediate positions that throttle the flow rate.

14. The multi-port valve assembly of claim 8, wherein each of the two or more flow channels is configured to facilitate fluid flow between three channel ports formed in the valve plug.

15. The multi-port valve assembly of claim 14, wherein at least one of the two or more flow channels is generally Y-shaped.

16. The multi-port valve assembly of claim 14, wherein at least one of the two or more flow channels is generally T-shaped.
